(19) United States
(12) Patent Application Publication
(10) Pub. No.: US 2024/0119543 A1
(43) Pub. Date: Apr. 11, 2024

(54) INFORMATION INQUIRY SERVICE SYSTEM AND INFORMATION INQUIRY METHOD

(71) Applicant: GS Yuasa International Ltd., Kyoto-shi, Kyoto (JP)

(72) Inventor: Daisuke SATO, Kyoto (JP)

(21) Appl. No.: 18/275,867

(22) PCT Filed: Jan. 19, 2022
(86) PCT No.: PCT/JP2022/001686

§ 371 Date: Aug. 4, 2023

(30) Foreign Application Priority Data
Feb. 10, 2021 (JP) 2021-019525

(51) Int. Cl. G06Q 50/06; B60L 53/66; G06Q 50/10

(52) U.S. Cl. CPC G06Q 50/06; B60L 53/66; G06Q 50/10

(57) ABSTRACT

An information inquiry service system U includes a charge-discharge station 50 for a vehicle, the charge-discharge station 50 including a charge-discharge device 51 and being connected to a network 110, and a server device 130 connected to the charge-discharge station 50 through the network 110. The charge-discharge station 50 transmits use information about each user of the charge-discharge station 50 to the server device 130. The server device 130 includes a storage unit 133 that stores the use record of the charge-discharge station 50 of each user based on the use information about each user transmitted from the charge-discharge station 50, and a control unit 131. The control unit 131 transmits information on the use record of the charge-discharge station 50 in response to a request from the client device 150 connected through the network 110 or as an event.

### TECHNICAL FIELD

The present invention relates to a technique for contributing to utilization of use information about a charge-discharge station.

### BACKGROUND ART

In recent years, electrification of a vehicle has progressed from the viewpoint of tightening environmental regulations and reducing CO₂ emissions, and preparation for a charge infrastructure is urgently needed for full-spread use of an electric vehicle (EV) and a plug-in hybrid electric vehicle (PHEV). On the other hand, there is a demand for a system capable of supplying power to a load when a power failure is generated during a disaster. In order to meet these requirements, a bidirectional charge-discharge device (charge-discharge stand) having a discharge function in addition to a charge function of the vehicle has been proposed (Patent Document 1).

### PRIOR ART DOCUMENT

### Patent Document

Patent Document 1: JP-A-2020-10442

### SUMMARY OF THE INVENTION

### Problems to be Solved by the Invention

There is room for studying the utilization of the use information (use date and time by user, use place, charge-discharge amount, and the like) of the charge-discharge station in which the charge-discharge device is installed.

The charge-discharge station is expected to have a function of supplying the power discharged from an in-vehicle battery of the EV or the PHEV to a public load or the like during the power failure or a peak cut. Conventionally, a mechanism of granting an incentive to an owner of the vehicle such as the EV or the PHEV has not been sufficiently studied.

The present invention provides a technique contributing to the utilization of the use information of the charge-discharge station.

### Means for Solving the Problems

An information inquiry service system according to one aspect of the present invention includes: a charge-discharge station for a vehicle, the charge-discharge station including a charge-discharge device and being connected to a network; and a server device connected to the charge-discharge station through the network, in which the charge-discharge station transmits use information about a user of the charge-discharge station to the server device, the server device includes: a storage unit that stores a use record of the charge-discharge station by the user based on the use information about the user transmitted from the charge-discharge station; and a control unit, and the control unit transmits information about the use record of the charge-discharge station in response to a request from a client device connected through the network or as an event.

This technique may be implemented as an information inquiry method for inquiring the use information about the charge-discharge station.

### Advantages of the Invention

According to the above aspect, the use information of the charge-discharge station can be utilized through the inquiry of the use information about the charge-discharge station.

### BRIEF DESCRIPTION OF THE DRAWINGS

FIG. 1. is a system configuration diagram illustrating a charge-discharge station.

FIG. 2 is a perspective view illustrating the charge-discharge station.

FIG. 3 is a perspective view illustrating a charge-discharge stand.

FIG. 4 is a system configuration diagram illustrating an information inquiry service system.

FIG. 5 is a block diagram illustrating the information inquiry service system.

FIG. 6 illustrates a storage content of a data sheet.

FIG. 7 is a flowchart illustrating inquiry processing.

FIG. 8 illustrates a login screen.

FIG. 9 illustrates an inquiry screen.

### MODE FOR CARRYING OUT THE INVENTION

An outline of an information inquiry service system will be described.

An information inquiry service system includes: a charge-discharge station for a vehicle, the charge-discharge station including a charge-discharge device and being connected to a network; and a server device connected to the charge-discharge station through the network, in which the charge-discharge station transmits use information about a user of the charge-discharge station to the server device, the server device includes: a storage unit that stores a use record of the charge-discharge station by the user based on the use information about the user transmitted from the charge-discharge station; and a control unit, and the control unit transmits information about the use record of the charge-discharge station in response to a request from a client device connected through the network or as an event.

Examples of transmitting information “as an event” include transmitting information at a constant period, and transmitting information by detecting a start or an end of the use of the charge-discharge device by the user. The information may be transmitted to the client device or may be transmitted to the charge-discharge station. When the information is transmitted to the charge-discharge station, the information may be displayed on a display panel of the charge-discharge device.

The charge-discharge station is expected to have a function of discharging an in-vehicle battery of an EV or a PHEV to supply power to a power load in a public facility such as a road service area, a hospital, or an evacuation center in an emergency such as a power failure. In such the emergency, it is assumed that the EV or the PHEV belonging to the public facility is mainly used for discharge to the load. In addition, there is a possibility the discharge from the EV or the PHEV that does not belong to the public facility (for example, it is owned by a user of a public facility) is accepted in the future.

In the configuration described above, the server device stores the use record of the charge-discharge station of each user. Thus, the use record of the charge-discharge station by various users such as a person who is an administrator of the public facility and uses the charge-discharge station, a user of the public facility, and a user who visits the charge-discharge station with a vehicle equipped with an in-vehicle battery for the purpose of power supply can be checked.

The use record may include a charge-discharge amount for each use.

In this configuration, the charge-discharge amount for each use by each user can be checked, so that the use information can be used for use tendency analysis, formulation of an energy in management plan in a community, and the like.

The server device may grant a privilege corresponding to the use record of the charge-discharge station.

In this configuration, the privilege can be granted to a beneficiary such as the user or a community. This is effective for evoking and improving a use desire to promote the use of the charge-discharge station.

### First Embodiment

Hereinafter, an embodiment of the present invention will be described with reference to the drawings, but the present invention is not limited to the embodiment.

### 1. Description of Charge-Discharge Station 50

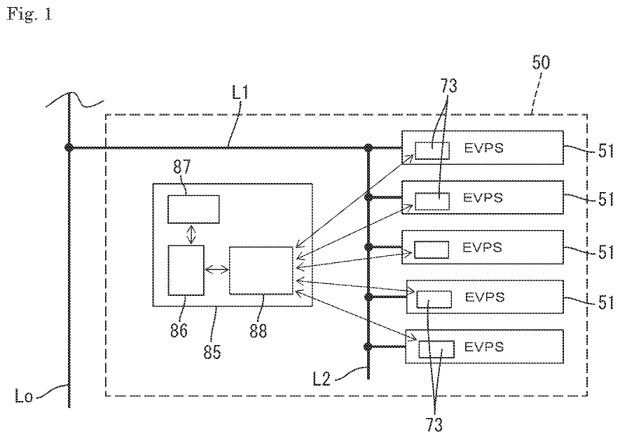

FIG. 1 is a system configuration diagram illustrating a charge-discharge station 50. The charge-discharge station 50 includes a plurality of charge-discharge stands 51 (EV power supplies) and a management device 85.

The charge-discharge stand 51 is an example of a “charge-discharge device”. The charge-discharge station 50 only needs to include at least one charge-discharge stand 51, but is not limited to a case where the plurality of charge-discharge stands 51 is provided.

Although not illustrated, instead of using the management device 85, one of the charge-discharge stands 51 may be used as a “master unit”, and the charge-discharge stand 51 may have a function of the management device 85.

Each charge-discharge stand. 51 is connected in parallel to an AC feeder Lo through branch lines L1, L2. The feeder Lo may be connected to a power system of an electric utility, or may be connected to a regional microgrid.

The charge-discharge station 50 may be installed in a public place such as a public parking lot, or alternatively, may be installed on a site of a company.

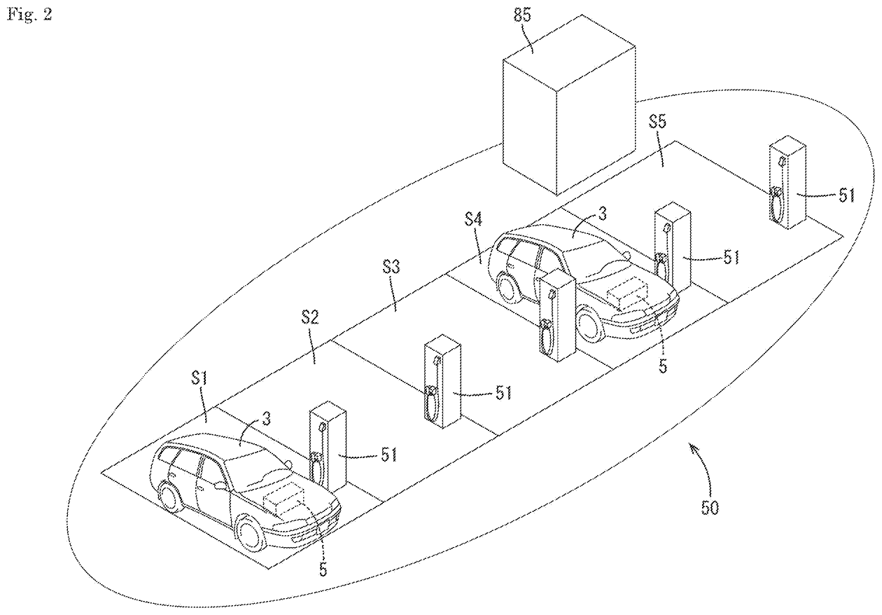

The charge-discharge station 50 may be a centralized type in which parking spaces S1 to S5 are arranged adjacent to each other as illustrated in FIG. 2, or may be a distributed type in which parking spaces are disposed in a distributed manner although not illustrated.

In the first embodiment, the charge-discharge stand 51 is provided in each parking space (S1, S2, . . . ) but the present invention is not limited to this form.

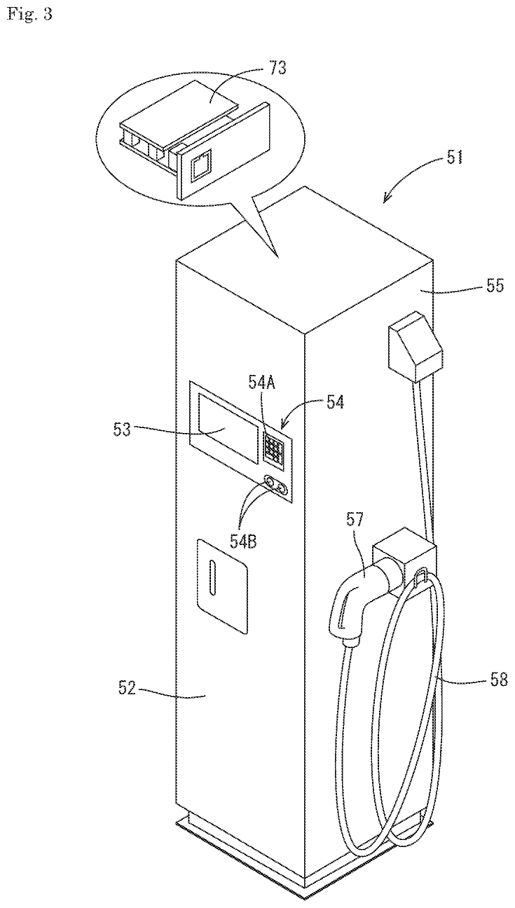

The charge-discharge stand 51 is, for example, a box shape elongated in a vertical direction as illustrated in FIG. 3, and includes a display panel 53 and an operation unit 54 on a front wall 52 of a housing. The operation unit 54 includes an input key 54A and an execution key 54B. The charge-discharge stand 51 includes a communication board 73 (for example, a network interface card) in the housing.

A side wall 55 of the housing holds a charge-discharge connector 57 and a charge-discharge cable 58.

The charge-discharge connector 57 is inserted into a connection portion (inlet) of the vehicle such as an automobile 3 in FIG. 2, and is fitted to a charge-discharge connector of the automobile 3.

The charg-e-discharge stand 51 and an in-vehicle battery 5 of the automobile 3 are electrically connected by fitting the connector, and the in-vehicle battery 5 can be charged or discharged through the charge-discharge stand 51.

The charge-discharge connector 57 connecting the charge-discharge stand 51 and the automobile 3 includes a signal line exchanging internal information about both sides in addition to a main circuit cable required for exchanging the power. The internal information about the automobile 3 includes information about a state of charge (SOC) of the in-vehicle battery 5. The charge-discharge stand 51 displays the SOC on display panel 53 based on the vehicle internal information obtained through the signal line.

The charge-discharge stand. 51 calculates a charge amount and a discharge amount of the in-vehicle battery 5 based on values detected by a current detection unit and a voltage detection unit provided inside the charge-discharge stand 51.

The communication board 73 of each charge-discharge stand 51 communicates with the management device 35 (see FIG. 1). When used by the user, each charge-discharge stands 51 that is a slave unit transmits use information about the charge-discharge stand 51 to the management device 85 that is a master unit.

The use information about the charge-discharge stand 51 includes “use date and time”, “use place”, “use time”, and “charge-discharge amount (charge amount and/or discharge amount)”.

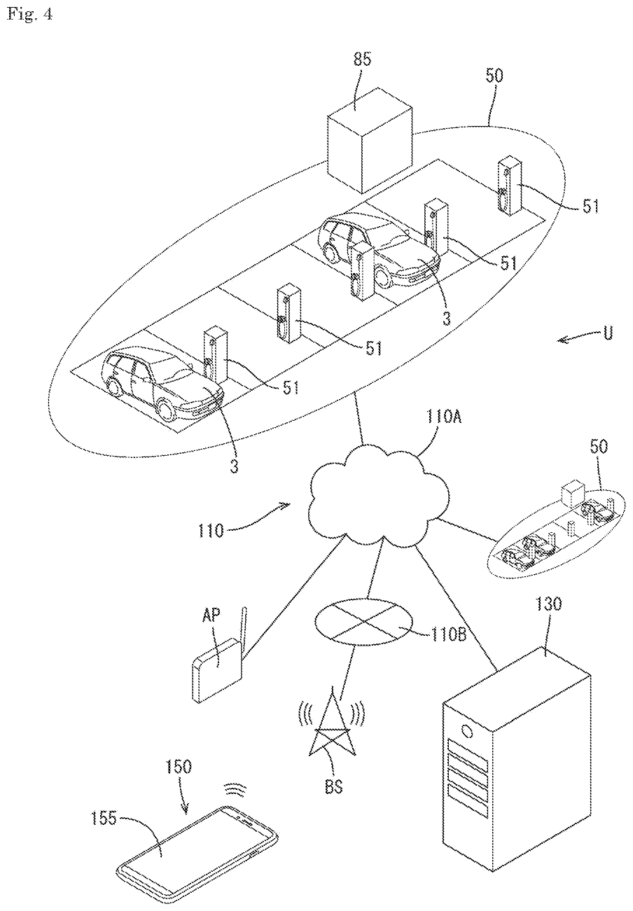

The management device 85 in FIG. 1 includes a control unit 86, a storage unit 87, and a communication device 88. The communication device 88 is used for communication with each of the charge-discharge stands 51 and a network 110 (see FIG. 4).

### 2. Information Inquiry Service System

As illustrated in FIG. 4, the charge-discharge station 50 is connected to the network 110 (wide area network). The charge-discharge station 50 connected to the network 110 may be singular or plural. FIG. 4 illustrates an example in which two charge-discharge stations 50 are connected to the network 110.

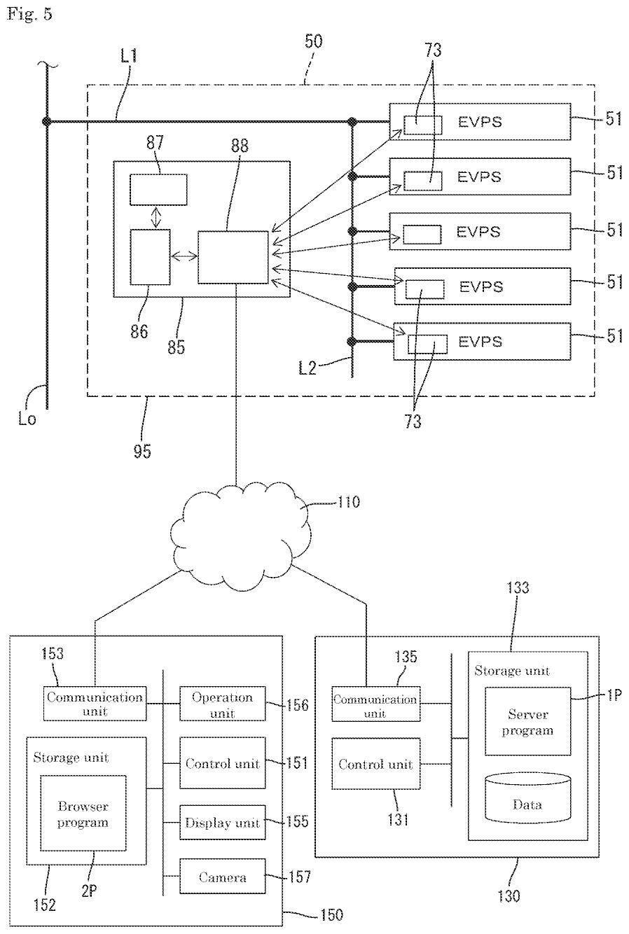

As illustrated in FIG. 5, the charge-discharge station 50 may be directly connected to the network 110 through the communication device 88, or may be connected through a LAN or a router. A method for connecting with the network 110 is not particularly limited.

As illustrated in FIG. 4, the network 110 may include a public communication network 110A that is what is called the Internet and a carrier network 110B. The carrier network 110B implements radio communication according to a predetermined mobile communication standard, and includes a base station BS.

As illustrated in FIGS. 4 and 5, a server device 130 is connected to the network 110.

The charge-discharge station 50 and the server device 130 configure an information inquiry service system U that allows the user of the charge-discharge station 50 to inquire the use record.

As illustrated in FIG. 5, the server device 130 uses a server computer and includes a control unit 131, a storage unit 133, and a communication unit 135. Although the server device 130 will be described as one server computer, processing may be distributed among a plurality of server computers.

A nonvolatile memory such as a hard disk or a flash memory is used as the storage unit 133, for example. The storage unit 133 stores a server program 1P. The server program 1P includes a web server program and a use record management program.

The control unit 131 performs the following processing by executing the server program 1P.
(A) Reception of login to web-based information inquiry service
(B) Production of web page based on use record of user
(C) Transmission produced web page to client device
(D) Management of use record and grant of privilege

The communication unit 135 implements communication connection and data transmission-reception through the network 110. The communication unit 135 may be a network interface card compatible with the network 110.

The server device 130 can perform personal identification authentication before the use of the charge-discharge stand 51 by the user.

A technique for authenticating the personal identification is not particularly limited. For example, the management device 85 may refer to the server device 130 to authenticate an identification number input using the input key 51A of the charge-discharge stand 51. That is, the personal authentication may be performed by specifying the identification number of the user from the identification numbers registered previously in the server device 130.

Alternatively, a two-dimensional barcode displayed on a portable communication terminal of the user may be read by a camera of the charge-discharge stand 51, and the information may be inquired from management device 85 to the server device 130 for the authentication.

When the user is identified by the personal identification authentication, the server device 130 associates the use information about the charge-discharge stand 51 transmitted from the management device 85 of each charge-discharge station 50 with the user, and manages the use information as the use record.

The use record of the charge-discharge station 50 managed by the server device 130 includes the following information.
(1) Number of use times
(2) Use date and time
(3) Use place
(4) Use time
(5) Charge-discharge amount
(6) Privilege

The “number of use times” is the number of times the user uses the charge-discharge station 50. The number of use times is not limited to the number of use times of the same station, but may be the total number of use times of each station when a plurality of charge-discharge stations 50 are connected to the network 110. The “use date and time” is a date and time when the user uses the charge-discharge station 50.

The “use place” is an installation place of the used charge-discharge station 50, and the “use time” is the use time of the charge-discharge station 50.

The “charge-discharge amount” includes a “charge amount”, a “discharge amount” and a “cumulative value”. The “charge amount” is an amount of electricity charged in the in-vehicle battery 5 of the automobile 3 through the charge-discharge stand 51. The “discharge amount” is an amount of electricity discharged from the in-vehicle battery 5 of the automobile 3 through the charge-discharge stand 51. The “cumulative value” is a total charge-discharge capacity obtained by integrating the charge-discharge amount at each use.

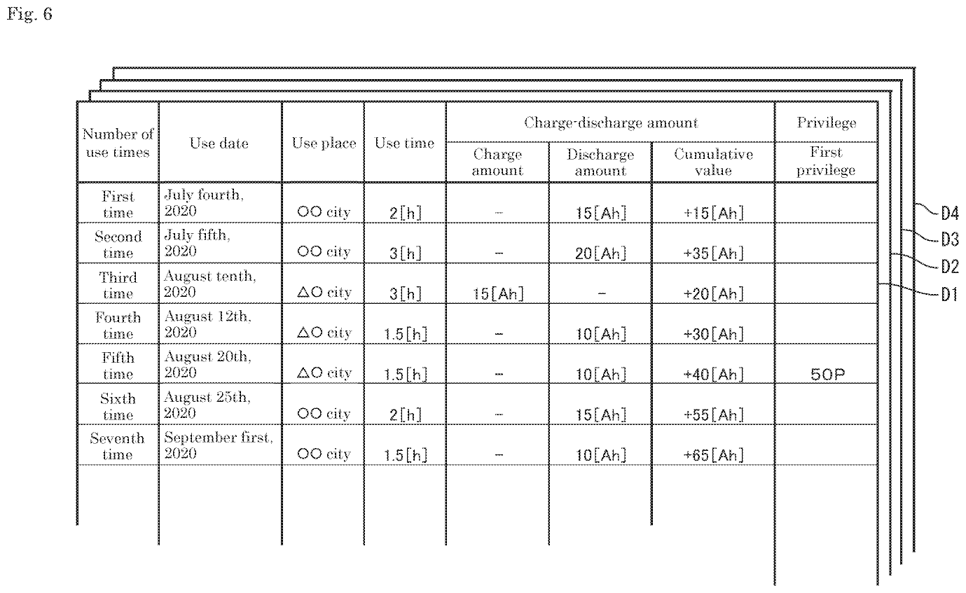

The “privilege” is granted according to the use record. In the first embodiment, a first privilege corresponding to the number of use times of the charge-discharge stand 51 is granted as an example of the privilege. In the example of FIG. 6, 50P (point) is granted as a use point every five use times. The use of the charge-discharge station 50 by the user can be promoted by granting the privilege according to the number of use times. For example, motivation of the user can be enhanced in order to utilize the EV and the PHEV for implementing energy management in the community.

The use point granted as the privilege may be exchangeable with an electronic coupon or a novelty, or may be exchangeable with electronic Money.

The server device 130 includes a plurality of data sheets (data files) D in the storage unit 133, and stores and manages the use record of each user in one data sheet D.

In the data sheet D, the use record is stored in association with the identification information about the user, and the data of the use record of each user can be read based on the identification information.

A client device 150 in FIGS. 4 and 5 is a computer used by the user of the charge-discharge station 50. The client device 150 may be what is called a smartphone or the portable communication terminal.

The client device 150 can communicate with the server device 130 from the base station BS through the network 110, and can communicate with the server device 130 through the network 110 or also through an access point AP.

As illustrated in FIG. 5, the client device 150 includes a control unit 151, a storage unit 152, a communication unit 153, a display unit 155, an operation unit 156, and a camera 157.

A nonvolatile memory such as a flash memory is used as the storage unit 152, for example. The storage unit 152 stores various programs including a browser program 2P. The browser program 2P includes a web browser program.

The control unit 151 is communicably connected to the server device 130 through the network 110 by the communication unit 153.

The control unit 151 executes the web browser program to cause the display unit 155 to display the web page provided by the server device 130.

The operation unit 156 may be a touch panel of the display unit 155 or a physical button provided on the housing. The operation unit 156 notifies the control unit 151 of operation information by the user.

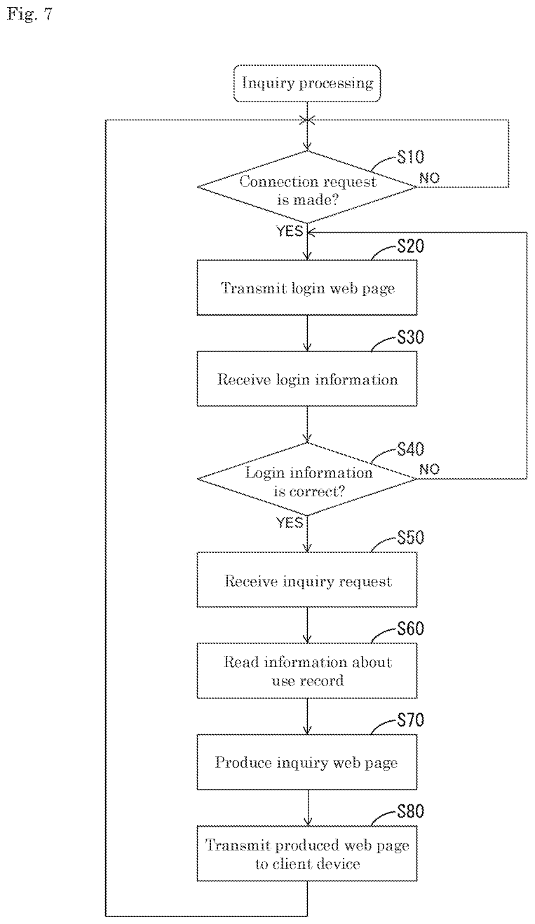

FIG. 7 is a flowchart illustrating use record inquiry processing.

The inquiry processing is executed by the server device 130, and includes eight steps of S10 to S80.

After starting the inquiry processing, the server device 130 shifts to a standby state of waiting for a connection request from the client device 150 (S10).

When receiving the inquiry service, the user of the charge-discharge station 50 clicks a link (connection information) on a web page displayed on the display unit 155 of the client device 150 to input a uniform resource locator (URL) of the server device 130.

With the input of the URL, a connection request (a request to access a login screen) is transmitted from the client device 150 to the server device 130 through the network 110, and the server device 130 receives the connection request. Accordingly, an affirmative determination is made in S10, and the processing proceeds to S20.

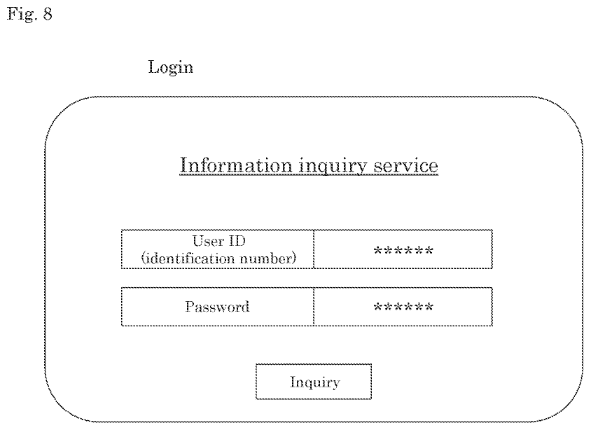

When the processing proceeds to S20, the server device 130 transmits the data of the web page of the login screen to the client device 150 in response to the connection request from the user. The transmitted login screen is displayed on the client device 150 of the user (see FIG. 8).

When the user inputs the login information on the login screen, namely, a “user ID” and a “password”, the login information is transmitted from the client device 150 to the server device 130. The transmitted login information is received by the server device 130 (S30).

The “user ID” may be the same as or different from the identification information about the user described above. When receiving the login information, the server device 130 determines whether the received login information is correct (S40).

When the login information is matched with the login information registered previously in the storage unit 133 (the case where both the input user ID and the password are matched with the registered user ID and the password), the server device 130 determines that the login information is correct.

When determining that the login information is correct, the server device 130 transmits an access permission to the client device 150. Thus, an “inquiry button” on the login screen in FIG. 8 is activated.

Thereafter, when the user operates the “inquiry button” on the login screen, an inquiry request is transmitted from the client device 150 to the server device 130, and the server device 130 receives the inquiry request (S50).

When receiving the inquiry request, the server device 130 accesses the storage unit 133, and reads the information about the use record of the user based on the identification information about the user (S60).

The server device 130 produces the data of the web page displaying the use record of the user (S70).

The server device 130 transmits the data of the produced web page to the client device 150 (S80).

After the transmission of the web page, the processing returns to S10, and the server device 130 enters a standby state of waiting for the next connection request.

The web page transmitted from the server device 130 is received by the client device 150.

The received web page is subjected to data processing by a web browser, whereby the data of the use record is displayed on the display unit 155 of the client device 150.

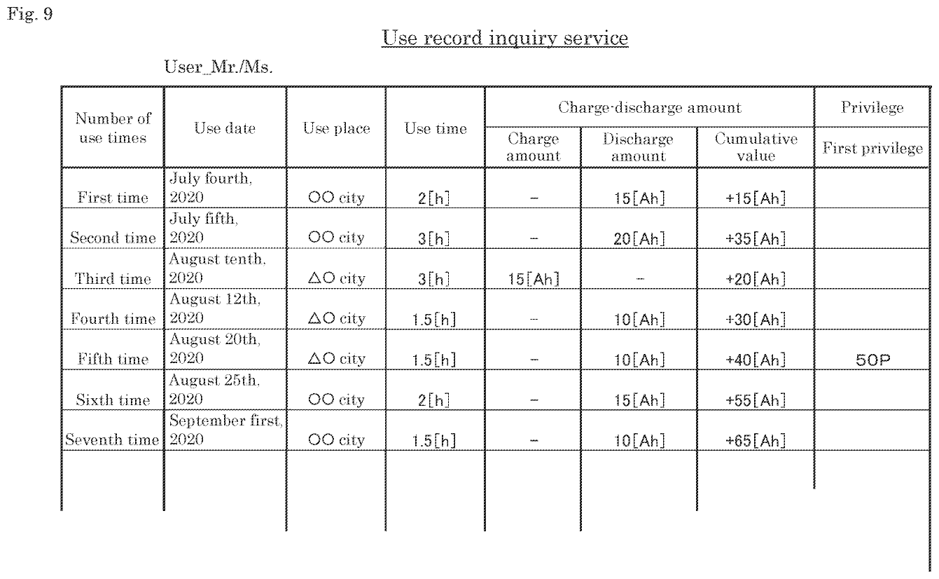

FIG. 9 illustrates a display example of the use record. In this example, as the use record, six items stored in the data sheet D are displayed in order of a use date (chronological order).

### 3. Description of Effect

The server device 130 stores the use record of the charge-discharge station 50 of each user, so that the use record of the charge-discharge station 50 can be checked by inquiring the server device 130.

Even when the discharge from the EV or the PHEV that does not belong to a public facility in which the charge-discharge station 50 is installed (for example, it is owned by the user of the public facility or owned by the user who visits the charge-discharge station for the purpose of supplying the power) is accepted, the result is stored in the server device. This is a mechanism useful for utilizing the use information particularly in the case where a power consumer (such as the public facility) and a power supplier (such as the user who visits the charge-discharge station for the purpose of supplying the power) are different.

Because the information inquiry service system U uses the wide area network 110, the use record can be checked from anywhere as long as the client device 150 can be connected to the wide area network 110. Therefore, many users can check the use record regardless of the place.

The inquiry can be easily made using the portable communication terminal having a high penetration rate as the client device 150.

The server device 130 grants the privilege according to the use record. Thus, the use desire can be evoked and improved to promote the use of the charge-discharge station 50.

In addition, the information inquiry service system U can be used not only for the inquiry of the use record but also for a meter-rate transaction associated with use of the charge-discharge station 50.

For example, the present invention can be used in a system that charges a metered amount of electricity usage (charge amount) during the charge and a system that purchases a metered amount of electricity supply (discharge amount) during the discharge.

### Other Embodiments

The present invention is not limited to the above described embodiment. For example, the following embodiments are also included in the technical scope of the present invention.

(1) In the embodiment, the in-vehicle battery 5 of the automobile 3 is charged or discharged using the charge-discharge stand 51. The charge-discharge stand 51 can be appropriately used for the vehicle other than the automobile 3 as long as the vehicle is mounted with the battery 5. For example, an electric motorcycle may be charged or discharged using the charge-discharge stand 51.

(2) In the embodiment, the client device 150 displays the data of the web page of the use record provided from the server device 130 by the web browser. Alternatively, the client device 150 may display the use record by dedicated browsing software (such as smartphone application) provided from the server device 130. The client device 150 is not limited to the portable communication terminal.

(3) In the embodiment, the first privilege granted according to the number of use times is exemplified as an example of the privilege granted according to the use record. The privilege granted according to the use record is not limited to the first privilege.

For example, a second privilege corresponding to the charge amount or the discharge amount for each use may be granted in place of or in combination with the first privilege. The second privilege may be granted according to a cumulative value (total charge-discharge amount) in addition to the charge amount and the discharge amount for each use. The second privilege may be granted according to any one of the charge amount, the discharge amount, and the cumulative value, or a combination thereof. The privilege is not limited to the use point, but may be in another form as long as the privilege can be obtained according to the use record. The privilege may be granted to the discharge from the vehicle when a power demand is high (for example, when a lowering demand response is performed) and/or the charge to the vehicle when the power is surplus (for example, when an increase demand response is performed, at night when the electricity is inexpensive, or the like).

When a request for the discharge from the vehicle is made to the owner of the vehicle (for example, when a power failure or a power shortage is generated in the charge-discharge station 50 including the power storage system and a discharge request is made), more privileges may be granted as the discharge from the vehicle is performed at an earlier timing from a request issue time point. Such the privilege can be granted by managing time information such as the use (late and time and the use time as the use record.

Many privileges may be granted when the discharge is performed from the vehicle (for example, the vehicle charged in a charging station combined with solar power generation or wind power generation) charged with the power derived from natural energy that does not emit carbon dioxide. Such the privilege can be granted by managing position information such as the use place as the use record.

(4) In the embodiment, the data of the use information is transmitted from the charge-discharge stand 51 that is the slave unit to the management device 85 that is the master unit. Alternatively, one of the plurality of charge-discharge stands 51 may be used as the master unit without using the dedicated management device 85. In this case, the charge-discharge stand 51 that is the master unit may be connected to the server device 130 through the network 110, and the use information about each charge-discharge stand 51 may be transmitted to the server device 130 through the master unit. The network 110 is not limited to a wide area network, but may be a local area network.

(5) In the embodiment, the “use (late and time”, the “use place”, the “use time”, and the “charge-discharge amount (charge amount (charge amount, discharge amount, cumulative value)” are indicated as the use information about the charge-discharge station 50, and the use information may be a part of these four pieces of information. Also in the use record, all the six pieces of information exemplified in the embodiment are not required to be managed, but only some pieces of information may be managed. The use information and the information managed as the use record are not limited to those exemplified in the embodiment, but may be any information regarding the use of the charge-discharge station 50.

(6) In the embodiment, the information about the use record of the charge-discharge station 50 is transmitted from the server device 130 to the client device 150. Alternatively, the information about the use record may be transmitted from the server device 130 to the charge-discharge station 50 from the start to the end of the use of the charge-discharge stand 51 by the user. In addition, the information about the use record may be displayed on the display panel 53 of the charge-discharge stand 51 for at least a certain period from the start to the end of the use of the charge-discharge stand 51 by the user. Through the display panel 53, whether to use the privilege corresponding to the use record in this opportunity may be asked by the user.

Because the information about the use record is displayed on the charge-discharge stand 51, the user is not required to possess the client device. At the start of the charge and the start of the discharge, the user gets off the vehicle, connects the charge-discharge connector 57 to a connection portion (inlet) of the vehicle, and operates the charge-discharge stand 51. Consequently, the user reliably visually recognizes the information about the use record displayed on the charge-discharge stand 51.

### DESCRIPTION OF REFERENCE SIGNS

50: charge-discharge station
51: charge-discharge stand (charge-discharge device)
85: management device
110: network
130: server device (information processing device)
150: client device (communication terminal)
U: information inquiry service system

1. An information inquiry service system comprising:
a charge-discharge station for a vehicle, the charge-discharge station including a charge-discharge device and being connected to a network; and
a server device connected to the charge-discharge station through the network,
wherein the charge-discharge station transmits use information about a user of the charge-discharge station to the server device,
the server device includes:
a storage unit that stores a use record of the charge-discharge station by the user based on the use information about the user transmitted from the charge-discharge station; and
a control unit, and
the control unit transmits information about the use record of the charge-discharge station in response to a request from a client device connected through the network or as an event.

2. The information inquiry service system according to claim 1, wherein the use record includes a charge-discharge amount for each use.

3. The information inquiry service system according to claim 1, wherein the server device grants a privilege corresponding to the use record of the charge-discharge station.

4. The information inquiry service system according to claim 3, wherein the server device grants the privilege according to a number of use times.

5. The information inquiry service system according to claim 3, wherein the server device grants a higher privilege to discharge from the vehicle when a power demand is high and/or charge to the vehicle when power is surplus as compared with the discharge from the vehicle and/or the charge to the vehicle at other timings.

6. The information inquiry service system according to claim 1, wherein the control unit transmits the information about the use record of the charge-discharge station to the charge-discharge station during a period from a start to an end of the use of the charge-discharge device by the user.

7. The information inquiry service system according to claim 6, wherein the information about the use record is displayed on a display panel of the charge-discharge device for at least a certain period from the start to the end of the use of the charge-discharge device by the user.

8. An information inquiry method comprising:
transmitting use information about each user of a charge-discharge station to a server device through a wide area network using the charge-discharge station for a vehicle, the charge-discharge station including a charge-discharge device;
storing a use record of the charge-discharge station of each user based on the use information about each user transmitted from the charge-discharge station using the server device; and
transmitting information about the use record of the charge-discharge station in response to a request from a client device connected through the wide area network or as an event using the server device.
